(19) United States
(12) Patent Application Publication
(10) Pub. No.: US 2022/0129212 A1
(43) Pub. Date: Apr. 28, 2022

(54) IMAGE FORMING APPARATUS CAPABLE OF PREVENTING PHENOMENON THAT PRINTING BY SCHEDULE SETTING WILL NOT BE STARTED DUE TO DISPLAY OF CONFIRMATION SCREEN, CONTROL METHOD FOR IMAGE FORMING APPARATUS, AND STORAGE MEDIUM

(71) Applicant: CANON KABUSHIKI KAISHA, Tokyo (JP)

(72) Inventors: Hiroaki Koike, Tokyo (JP); Atsushi Ikeda, Ibaraki (JP); Takeshi Kogure, Ibaraki (JP)

(21) Appl. No.: 17/500,419

(22) Filed: Oct. 13, 2021

(30) Foreign Application Priority Data
Oct. 26, 2020 (JP) 2020-178839

(51) Int. Cl. G06F 3/12

(52) U.S. Cl. CPC G06F 3/126; G06F 3/1258; G06F 3/1204

(57) ABSTRACT

An image forming apparatus capable of preventing a phenomenon that printing by a schedule setting will not be started due to display of a confirmation screen is provided. The image forming apparatus comprising a display unit, a registering unit configured to register an object associated with a print timing condition and a printing setting designated by a user, and a printing unit configured to print an image on a paper sheet. When the object displayed on the display unit is selected, the display unit displays a confirmation screen. According to accepting of a predetermined operation in a state that the confirmation screen is displayed, the printing unit prints an image on a paper sheet based on the printing setting. By satisfying the print timing condition, the display unit does not display the confirmation screen, and the printing unit prints the image on the paper sheet based on the printing setting.

### BACKGROUND OF THE INVENTION

### Field of the Invention

The present invention relates to an image forming apparatus, a control method for the image forming apparatus, and a storage medium.

### Description of the Related Art

An image forming apparatus, which have an execution environment for executing applications, is known. The image forming apparatus realizes operations of the application on firmware of the image forming apparatus by executing the application in this execution environment. An operation button corresponding to an application (hereinafter referred to as “an application button”) is displayed on an operation screen of the image forming apparatus, and setting information is registered in association with the application button. The image forming apparatus obtains, for example, data to be printed based on a printing setting associated with the application button pressed by a user, and further performs printing of the obtained data (for example, see Japanese Laid-Open Patent Publication (kokai) No. 2017-148978). In addition, the image forming apparatus has a setting confirmation function that allows the user to confirm the printing setting. In the case that the setting confirmation function is set to be enabled, before starting printing based on the printing setting associated with the application button pressed by the user, the image forming apparatus displays a confirmation screen that allows the user to confirm this printing setting. When receiving a printing start instruction from the user in a state that the confirmation screen is displayed, the image forming apparatus starts the printing based on the above printing setting.

In the image forming apparatus, in addition to the printing setting, it is also possible to register a schedule setting in association with the application button. When the user presses an application button that the schedule setting is registered, the image forming apparatus starts the printing at a time point associated with the application button, not immediately after the said application button is pressed. As a result, even in the case that the user is not near the image forming apparatus, the printing can be started at the intended time point.

However, conventionally, in printing by the schedule setting, the printing sometimes can not be started at the time point associated with the application button. Here, in the image forming apparatus that the setting confirmation function is set to be enabled, although the printing will not be started unless the image forming apparatus receives the printing start instruction from the user in the state that the confirmation screen is displayed, in the printing by the schedule setting, it is conceivable that the user is not near the image forming apparatus when the printing is started. Therefore, in the printing by the schedule setting, if the printing start instruction is not given in the state that the confirmation screen is displayed, the printing will not be started at the time point associated with the application button. As described above, conventionally, it is not possible to start the printing by the schedule setting due to display of the confirmation screen.

### SUMMARY OF THE INVENTION

The present invention provides an image forming apparatus capable of preventing a phenomenon that printing by a schedule setting will not be started due to display of a confirmation screen, a control method for the image forming apparatus, and a storage medium.

Accordingly, the present invention provides an image forming apparatus comprising a display unit, a registering unit configured to register an object associated with a print timing condition and a printing setting designated by a user; and a printing unit configured to print an image on a paper sheet, wherein when the object displayed on the display unit is selected, the display unit displays a confirmation screen, wherein according to accepting of a predetermined operation in a state that the confirmation screen is displayed, the printing unit prints an image on a paper sheet based on the printing setting, and wherein by satisfying the print timing condition, the display unit does not display the confirmation screen, and the printing unit prints the image on the paper sheet based on the printing setting.

According to the present invention, it is possible to prevent the phenomenon that the printing by the schedule setting will not be started due to display of the confirmation screen.

Further features of the present invention will become apparent from the following description of exemplary embodiments with reference to the attached drawings.

### BRIEF DESCRIPTION OF THE DRAWINGS

FIG. 1 is a block diagram that schematically shows a configuration of an image forming apparatus according to an embodiment of the present invention.

FIG. 2 is a block diagram that schematically shows a configuration of an execution environment of expanded applications installed in the image forming apparatus of FIG. 1.

FIG. 3 is a block diagram that schematically shows a configuration of a software module running on a CPU of FIG. 1.

FIG. 4 is a diagram that shows a network configuration in the case of installing a new expanded application in the image forming apparatus of FIG. 1.

FIG. 5 is a sequence diagram that shows procedures of a processing of installing the new expanded application from a host PC of FIG. 4 to the image forming apparatus.

FIG. 6 is a figure that shows a structure of installation data provided from the host PC of FIG. 4.

FIG. 7 is a figure that shows one example of a setting screen of the expanded application of FIG. 2.

FIG. 8 is a figure that shows one example of setting data of the expanded application of FIG. 2.

FIG. 9 is a sequence diagram that shows procedures of an expanded application setting processing, which is performed based on settings of the setting screen of FIG. 7.

FIG. 10 is a sequence diagram that shows procedures of a printing job control processing, which is performed when an icon of the expanded application displayed on an operating unit of FIG. 1 is pressed.

FIG. 11 is a figure that shows one example of a file error screen displayed on the operating unit of FIG. 1.

FIG. 12 is a figure that shows one example of a pre-execution confirmation screen displayed on the operating unit of FIG. 1.

FIG. 13 is a figure that shows one example of a printing processing-in progress screen displayed on the operating unit of FIG. 1.

FIG. 14 is a figure that shows one example of an error screen displayed on the operating unit of FIG. 1.

FIG. 15 is a figure for explaining operations of the image forming apparatus in the case of printing a multi-page document.

FIG. 16 is a flowchart that shows procedures of a printing job submitting processing executed by the image forming apparatus and a server in the present embodiment.

FIG. 17 is a flowchart that shows procedures of another printing job submitting processing executed by the image forming apparatus and the server in the present embodiment.

### DESCRIPTION OF THE EMBODIMENTS

The present invention will now be described in detail below with reference to the accompanying drawings showing embodiments thereof.

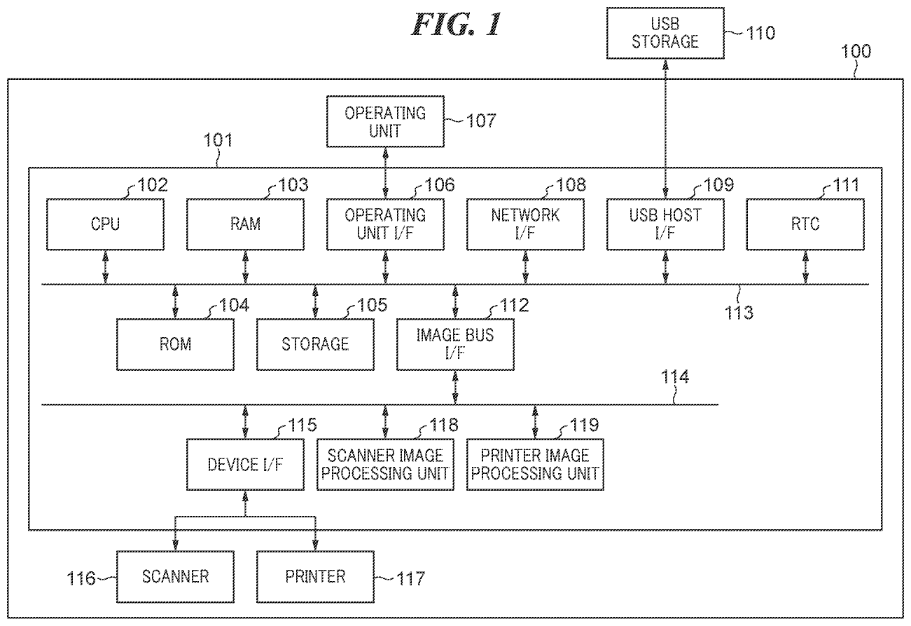

FIG. 1 is a block diagram that schematically shows a configuration of an image forming apparatus 100 according to an embodiment of the present invention. As shown in FIG. 1, the image forming apparatus 100 has a control unit 101, an operating unit 107, a scanner 116, and a printer 117. The control unit 101 is connected to the operating unit 107, the scanner 116, and the printer 117, respectively. Further, the control unit 101 has a CPU (Central Processing Unit) 102, a RAM (Random Access Memory) 103, a ROM (Read Only Memory) 104, a storage 105, an operating unit I/F (interface) 106, a network I/F 108, and a USB (Universal Serial Bus) host I/F 109, an RTC (Real-Time Clock) 111, an image bus I/F 112, a device I/F 115, a scanner image processing unit 118, and a printer image processing unit 119. The CPU 102, the RAM 103, the ROM 104, the storage 105, the operating unit I/F 106, the network I/F 108, the USB host I/F 109, and the RTC 111 are connected to each other via a system bus 113. Further, an image bus 114 is connected to the system bus 113 via the image bus I/F 112. Furthermore, the device I/F 115, the scanner image processing unit 118, and the printer image processing unit 119 are connected to the image bus 114.

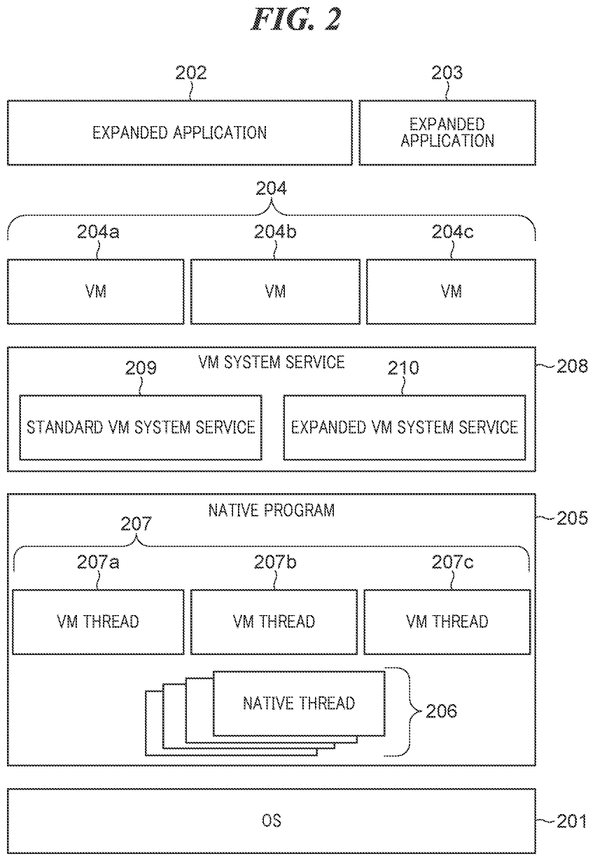

The image forming apparatus 100 has a plurality of functions such as a scan function, a print function, a copy function, and a data communication function. The control unit 101 performs control for realizing various functions of the image forming apparatus 100. For example, the control unit 101 performs control for realizing the copy function, which generates image data of a document read by the scanner 116 and prints the said image data by means of the printer 117 functioning as a printing unit. The CPU 102 starts up an operating system (hereinafter, referred to as “OS”) 201 of FIG. 2 by means of a boot program stored in the ROM 104. The CPU 102 executes programs, which are stored in the storage 105, on the OS 201. As a result, the control for realizing various functions of the image forming apparatus 100, is performed. The RAM 103 is used as a working area of the CPU 102 and is also used as an image memory area for temporarily storing the image data. The ROM 104 stores programs. The storage 105 stores the programs and the image data.

The operating unit I/F 106 is an interface between a touch panel type operating unit 107 and the control unit 101. The operating unit I/F 106 outputs image data for display to the operating unit 107. Further, the operating unit I/F 106 transfers information, which is inputted into the operating unit 107 by the user, to the CPU 102. The operating unit 107 is a user interface of the image forming apparatus 100. The network I/F 108 is an interface for connecting the image forming apparatus 100 to a LAN (Local Area Network) (not shown). The USB host I/F 109 is an interface unit that communicates with a USB storage 110 connected to the image forming apparatus 100. The USB host I/F 109 outputs data, which is stored in the storage 105, to the USB storage 110. Further, the USB host I/F 109 obtains the data stored in the USB storage 110 and notifies the CPU 102 that the data has been obtained. The USB storage 110 is an external storage device that stores data, and can be attached to or detached from the USB host I/F 109. A plurality of USB devices including the USB storage 110 can be connected to the USB host I/F 109. The RTC 111 outputs a current time point. Information about time point, which is outputted from the RTC 111, is used for recording of a submitting time of the job, and the like.

The image bus I/F 112 is a bus bridge that converts a data format. Further, the image bus I/F 112 connects the system bus 113 and the image bus 114. The image bus 114 is a bus capable of transferring the image data at high speed, and is configured by a PCI (Peripheral Component Interconnect) bus, IEEE 1394, and the like. The device I/F 115 performs a synchronous/asynchronous conversion of the image data. The scanner 116 and the printer 117 are connected to the device I/F 115. The scanner image processing unit 118 performs correcting, processing, and editing with respect to the image data of the document read by the scanner 116. The printer image processing unit 119 performs correcting, resolution converting, etc. that correspond to the printer 117 with respect to the image data to be outputted to the printer 117.

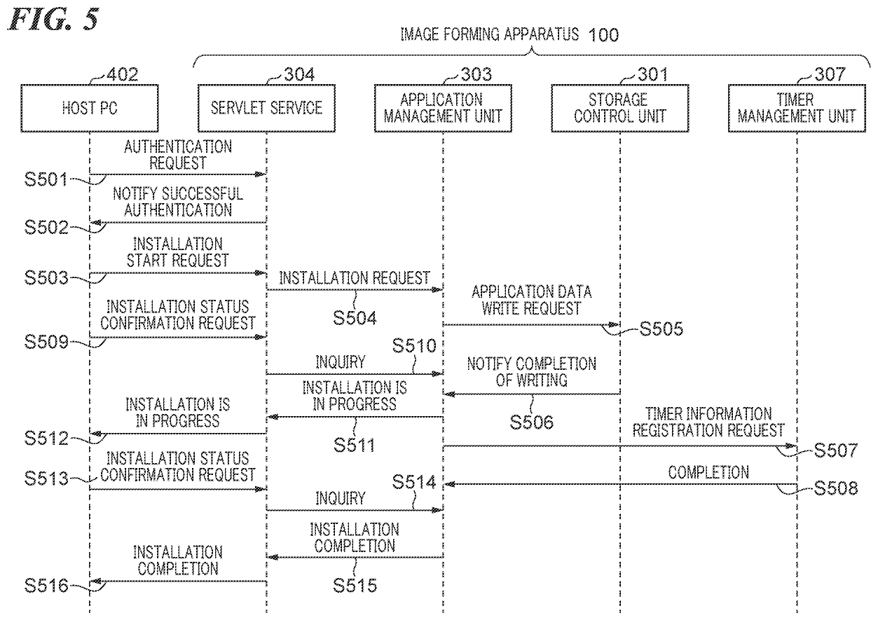

FIG. 2 is a block diagram that schematically shows a configuration of an execution environment of expanded applications installed in the image forming apparatus 100 of FIG. 1. FIG. 2 shows the configuration that two different expanded applications 202 and 203 are already installed in the image forming apparatus 100 by a processing of FIG. 5 that will be described later. In the image forming apparatus 100, each module of FIG. 2 is realized by the CPU 102 loading the program stored in the storage 105 into the RAM 103 and executing the loaded program.

A virtual machine (hereinafter referred to as “VM”) 204 and a native program 205 are running on the OS 201. The VM 204 is the execution environment of the expanded applications 202 and 203. The VM 204 is generated for each thread of the expanded application installed in the image forming apparatus 100. FIG. 2 shows the configuration that a VM 204a and a VM 204b for running two threads of the expanded application 202 are generated, and a VM 204c for running one thread of the expanded application 203 is generated. Hereinafter, the VM 204a, the VM 204b, and the VM 204c are collectively referred to as “the VM 204”. The VM 204 is a module that interprets a program, which controls the expanded application 202 and the expanded application 203, and executes the said program.

The expanded application 202 and the expanded application 203 run on the VM 204. Programs, which run on the VM 204, run according to commands dedicated to the VM 204 that are different from commands running on the CPU 102 (hereinafter, referred to as “commands dedicated to the CPU 102”). Hereinafter, the command dedicated to the VM 204 is referred to as “a byte code”, and the command dedicated to the CPU 102 is referred to as “a native code”. The VM 204 sequentially interprets and processes the byte code, so that the native code and the byte code of the VM 204 run on the CPU 102. Moreover, in the present embodiment, the configuration using the VM that sequentially interprets and processes the byte code will be described, but the type of the VM used is not limited to this type of the VM. For example, a VM, which converts a bytecode into a native code and then executes, may be used. In general, just as the commands running on the CPUs are incompatible if the type of the CPUs are different, the commands running on the VMs are also incompatible if the VMs are different. Further, although the VM 204 in the present embodiment is described as a software module that runs on the CPU 102, the VM 204 may be a hardware module.

The native program 205 includes a native thread 206 for controlling image processing units such as the printer, a fax (facsimile) unit, and the scanner, and a VM thread 207 for running the VM 204. The native program 205 includes the same number of VM threads as the number of the VMs 204. In the present embodiment, as an example, the native program 205 includes three VM threads, specifically, a VM thread 207a, a VM thread 207b, and a VM thread 207c. The VM thread 207a corresponds to the VM 204a, the VM thread 207b corresponds to the VM 204b, and the VM thread 207c corresponds to the VM 204c. Moreover, hereinafter, the VM thread 207a, the VM thread 207b, and the VM thread 207c are collectively referred to as “the VM thread 207”.

A VM system service 208 is a utility library that is used by both the expanded application 202 and the expanded application 203. The image forming apparatus 100 can access to each module of the image forming apparatus 100 while saving time and labor for developing the expanded application by calling functions of the VM system service 208 from the expanded application 202 or the expanded application 203. The VM system service 208 has a standard VM system service 209 and an expanded VM system service 210. The standard VM system service 209 is a module required for operations as the VM. Further, the standard VM system service 209 also includes a function of loading the expanded application 202 and the expanded application 203. The expanded VM system service 210 provides a function of accessing to each module of the image forming apparatus 100 and the OS 201. In the image forming apparatus 100, the VM system service 208 associated with an API (Application Programming Interface) is called by the VM 204 executing the API specified by the byte code of the expanded application 202 or the expanded application 203.

Icons (objects) corresponding to the expanded application 202 and the expanded application 203 respectively are displayed on a main menu screen (not shown), which is displayed on the operating unit 107 of the image forming apparatus 100. For example, when the operating unit I/F 106 detects through the operating unit 107 that the user has selected the icon of the expanded application 202, the operating unit I/F 106 transmits a notification, which indicates that the user has selected the icon of the expanded application 202, to the CPU 102. Upon receiving this notification, the CPU 102 activates the expanded application 202 selected by the user.

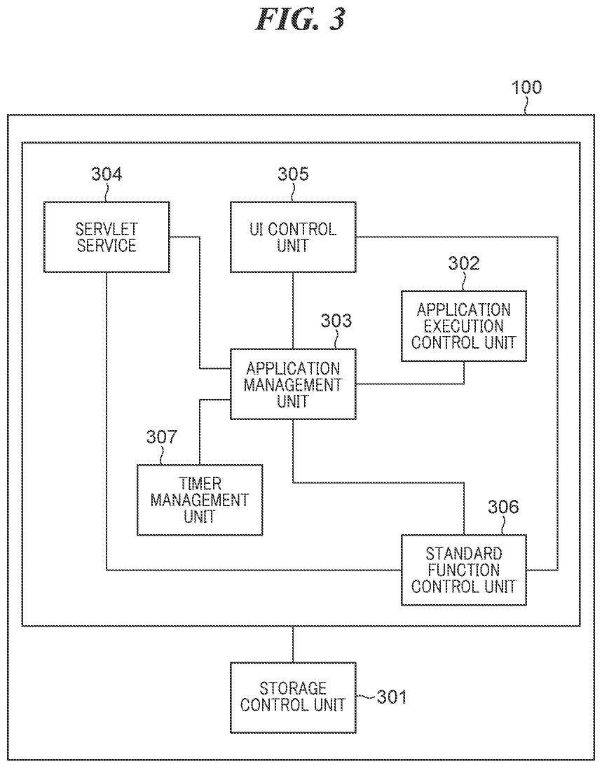

FIG. 3 is a block diagram that schematically shows a configuration of a software module running on the CPU 102 of FIG. 1. As shown in FIG. 3, as the software module that runs on the CPU 102, the image forming apparatus 100 has a storage control unit 301, an application execution control unit 302, an application management unit 303, a servlet service 304, a UI (User Interface) control unit 305, a standard function control unit 306, and a timer management unit 307.

The storage control unit 301 records and manages respective programs and setting information of the expanded application 202 and the expanded application 203. The application execution control unit 302 accesses to the storage control unit 301 to read the program of the application, and controls the execution of the application activated by the application management unit 303. Specifically, the application execution control unit 302 controls the VM thread 207, the VM system service 208, the VM 204, the expanded application 202, and the expanded application 203. Each module accesses to the storage control unit 301 to refer to and set setting values. The application management unit 303 manages the expanded application installed in the image forming apparatus 100, the activation of the installed expanded application, etc.

When the servlet service 304 is accessed by HTTP (Hyper Text Transfer Protocol) through the network I/F 108 based on a specified URL (Uniform Resource Locator), the servlet service 304 assigns processes to the application management unit 303 and the standard function control unit 306 based on the said URL. The UI control unit 305 performs control that displays a screen on the operating unit 107 functioning as a display unit, and notifies the application management unit 303 and the standard function control unit 306 of operation information, which is inputted into the operating unit 107 by the user. The standard function control unit 306 performs the control of the copy function and the fax function, which are standard functions of the image forming apparatus 100, and other control necessary for the image forming apparatus 100, for example, the control of the USB host I/F 109. The timer management unit 307 obtains the current time point from the RTC 111, and when detecting that a designated time point has been reached, notifies the application management unit 303 that the designated time point has been reached. Upon receiving this notification, the application management unit 303 requests the application execution control unit 302 to execute a timer processing of the application based on the said notification.

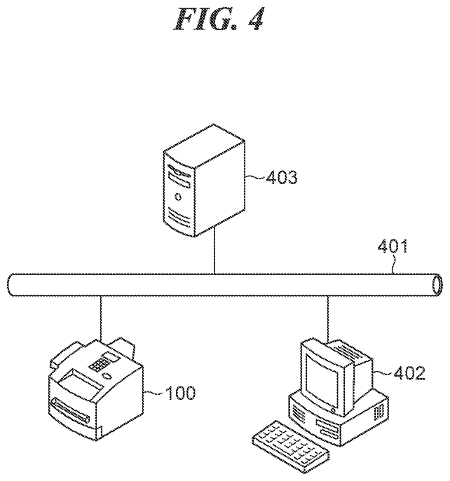

FIG. 4 is a diagram that shows a network configuration in the case of installing a new expanded application in the image forming apparatus 100 of FIG. 1.

The image forming apparatus 100 provides a host PC (personal computer) 402 with an installation means (an installation method) for installing the expanded application via an Ethernet (registered trademark) 401. The host PC 402 retains installation data of the expanded application. The host PC 402 installs the new expanded application in the image forming apparatus 100 by using the installation means of the expanded application, which is provided by the image forming apparatus 100. A server 403 (an information processing apparatus) retains a plurality of image data. When the server 403 receives an image data obtaining request from the image forming apparatus 100 that functions as an obtaining unit, the server 403 transmits image data corresponding to the image data obtaining request to the image forming apparatus 100.

FIG. 5 is a sequence diagram that shows procedures of a processing of installing the new expanded application from the host PC 402 of FIG. 4 to the image forming apparatus 100. In FIG. 5, as an example, a case of installing the expanded application 202 in the image forming apparatus 100 will be described.

As shown in FIG. 5, at first, the host PC 402 makes an authentication request for installing the expanded application 202 in the image forming apparatus 100 (a step S501). In the step S501, the host PC 402 transmits authentication information necessary for authentication, for example, a user ID (identification) and a password to the image forming apparatus 100.

The servlet service 304 of the image forming apparatus 100 performs the authentication based on the received authentication information, and when the authentication is successful, notifies the host PC 402 that the authentication is successful (a step S502). Specifically, the servlet service 304 transmits a character string (a token) indicating that the authentication is successful to the host PC 402.

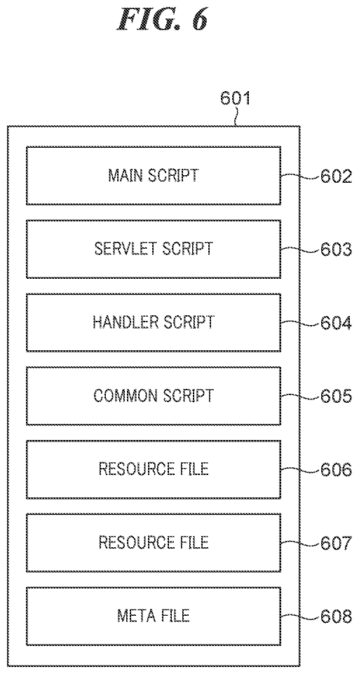

Upon receiving this notification, the host PC 402 notifies the image forming apparatus 100 of an installation start request (a step S503). In the step S503, the host PC 402 notifies installation data 601 of FIG. 6, which will be described later and is retained by the said host PC 402, and the token obtained in the step S502.

The servlet service 304 of the image forming apparatus 100 that has received the installation start request authenticates the received token. If there is no problem in the received token, the servlet service 304 makes an installation request of the expanded application 202 to the application management unit 303 (a step S504). Upon receiving the installation request, the application management unit 303 makes an application data write request to the storage control unit 301 (a step S505). Upon receiving the application data write request, the storage control unit 301 writes the installation data 601, which will be described later and is obtained from the host PC 402, into the storage 105. When the writing is completed, the storage control unit 301 notifies the application management unit 303 of the completion of the writing (a step S506). The application management unit 303 makes a registration request of timer information included in the installation data 601 described later to the timer management unit 307 (a step S507). When the timer management unit 307 completes the registration of the timer information, the timer management unit 307 notifies the application management unit 303 of the completion of the registration of the timer information (a step S508).

On the other hand, the host PC 402 can make an installation status obtaining request to the image forming apparatus 100 after making the installation start request. When making the installation status obtaining request, the host PC 402 notifies the token obtained in the step S502.

For example, as in a step S509, in a case that the host PC 402 has made the installation start request to the image forming apparatus 100 at a timing when the writing of the installation data 601 described later is not completed, the servlet service 304 authenticates the received token. If there is no problem in the received token, the servlet service 304 makes an inquiry about an installation status to the application management unit 303 (a step S510). Upon receiving this inquiry, the application management unit 303 notifies the servlet service 304 that the installation is in progress as the installation status (a step S511). The servlet service 304 notifies the host PC 402 of the installation status (the installation is in progress) obtained from the application management unit 303 (a step S512).

Further, as in a step S513, in a case that the host PC 402 has made the installation start request to the image forming apparatus 100 after completing the writing of the installation data 601 described later, as with the step S510, the servlet service 304 makes an inquiry about the installation status to the application management unit 303 (a step S514). Upon receiving this inquiry, the application management unit 303 notifies the servlet service 304 that the installation has been completed as the installation status (a step S515). The servlet service 304 notifies the host PC 402 of the installation status (the installation has been completed) obtained from the application management unit 303 (a step S516).

Similarly, the image forming apparatus 100 obtains installation data of the expanded application 203 from the host PC 402, and installs the expanded application 203 in the image forming apparatus 100.

FIG. 6 is a figure that shows a structure of the installation data 601 provided from the host PC 402 of FIG. 4. The installation data 601 is data obtained by putting all the data constituting the expanded application 202 together. Files that constitute the installation data 601 are roughly classified into three types.

The first type of the files are scripts that describe operations of the expanded application 202 in a programming language, specifically, a main script 602, a servlet script 603, a handler script 604, and a common script 605. The main script 602 describes the operation when the icon of the expanded application 202 displayed on the operating unit 107 is pressed. The servlet script 603 describes the processing of the servlet service 304. The handler script 604 describes the timer processing. The common script 605 is a script used by the main script 602, the servlet script 603, and the handler script 604 in common.

The second type of the files are resource files 606 and 607 that store image data, display messages, and the like that are used by the expanded application 202. The third type of the files is a meta file 608 that declares the name of the expanded application 202, etc. Moreover, in the present embodiment, the structure of the installation data 601 of the expanded application 202 has been described, but the installation data of the expanded application 203 also has the same structure. In the image forming apparatus 100, when the expanded application 202 or the expanded application 203 is executed, since only the necessary scripts are loaded into the RAM 103, unnecessary occupation of the RAM 103 due to the loading of the scripts is suppressed.

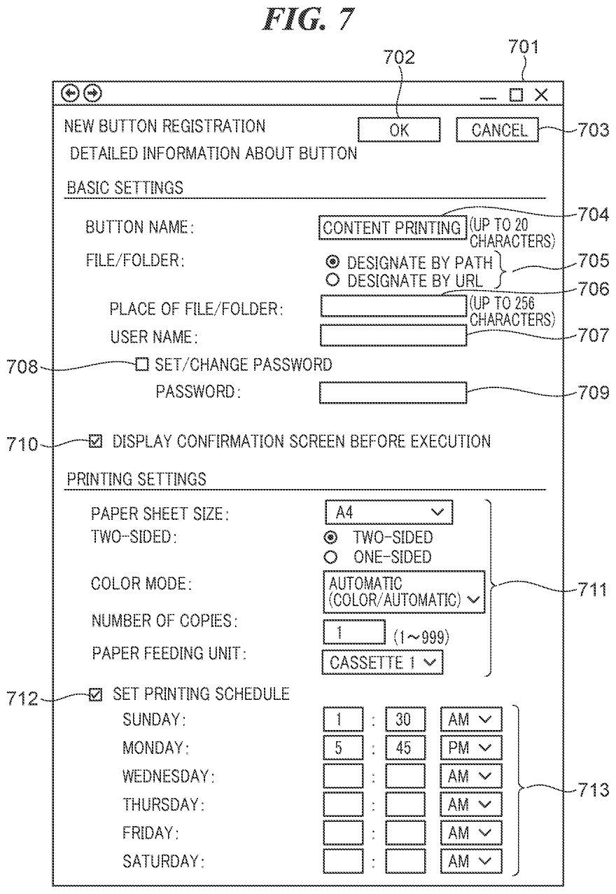

FIG. 7 is a figure that shows one example of a setting screen 701 of the expanded application 202 of FIG. 2. The setting screen 701 is displayed on a web browser, which runs on the host PC 402 connected to the image forming apparatus 100 by means of the ethernet 401.

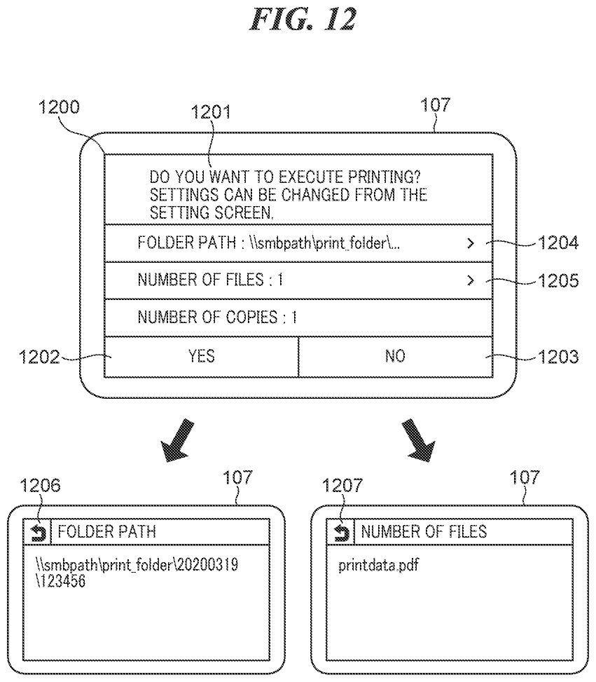

The setting screen 701 includes an “OK” button 702 and a “CANCEL” button 703. Further, as basic settings, the setting screen 701 includes a button name 704, a radio button 705, a place of file/folder 706, a user name 707, a check box 708, a password 709, and a check box 710. The name of the icon of the expanded application 202, which is displayed on the main menu screen (not shown) of the operating unit 107 of the image forming apparatus 100, is set in the button name 704. The radio button 705 is a button for setting whether to designate information about file/folder by a path or a URL. Information indicating a storage place of a file to be printed is set in the place of file/folder 706. For example, URL information for specifying the file to be printed and path information of a folder, in which the file to be printed is stored, are set in the place of file/folder 706. A user name necessary for accessing to the file, which is set in the place of file/folder 706, is set in the user name 707. In the check box 708, whether or not to set or change the password is set. For example, in the case that the check box 708 is in a selected state, the user can edit the value of the password 709. A password necessary for accessing to the file, which is set in the place of file/folder 706, is set in the password 709. In the check box 710, whether or not to display a pre-execution confirmation screen 1200 of FIG. 12, which will be described later, when the icon of the expanded application 202 displayed on the operating unit 107 of the image forming apparatus 100 is pressed, is set. For example, in the case that the check box 710 is in the selected state, when the icon of the expanded application 202 is pressed on the operating unit 107, the pre-execution confirmation screen 1200 described later is displayed on the operating unit 107.

The setting screen 701 further includes printing setting items 711 such as “paper sheet size”, “two-sided”, “color mode”, “number of copies”, and “paper feeding unit”, a check box 712, and a schedule setting 713 for executing printing on a designated day of a week and time. In the check box 712, whether or not to enable the printing schedule setting that executes the printing on the designated day of the week and time is set. In the schedule setting 713, in the case that the check box 712 is in the selected state, that is, in the case that the printing schedule setting is set to be enabled, a print timing condition, specifically, a time to execute printing is set for each day of the week.

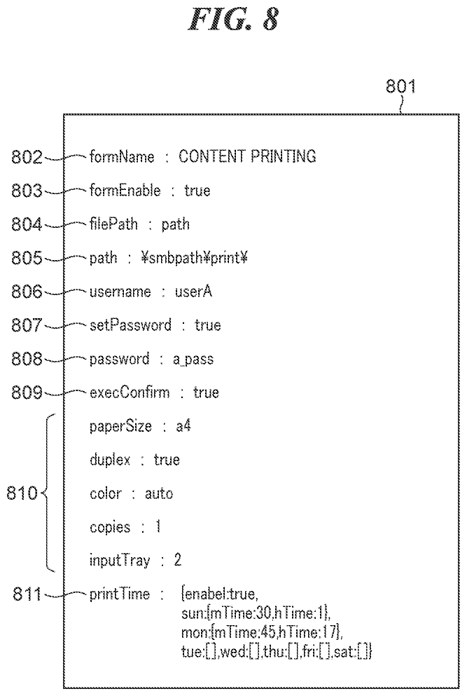

When the “OK” button 702 is pressed on the setting screen 701, values set on the setting screen 701 are stored in the storage 105 as setting data 801 of FIG. 8. Further, the icon of the expanded application 202 that calls the setting data 801 is displayed on the main menu screen (not shown) of the operating unit 107 of the image forming apparatus 100. On the other hand, when the “CANCEL” button 703 is pressed on the setting screen 701, the setting of the setting screen 701 is discarded and the setting screen 701 is closed.

FIG. 8 is a figure that shows one example of the setting data 801 of the expanded application 202 of FIG. 2. As shown in FIG. 8, the setting data 801 includes items 802 to 809 corresponding to the basic settings of the setting screen 701, an item 810 corresponding to the printing setting of the setting screen 701, and an item 811 corresponding to the printing schedule setting of the setting screen 701. A value set in the button name 704 is set in the item 802. In the item 803, a value indicating whether or not to display the icon of the expanded application 202 on the operating unit 107 is set. In the item 804, a setting value of the radio button 705, that is, a value indicating whether to designate the information about file/folder by a path or a URL is set. A value set in the place of file/folder 706 is set in the item 805. A value set in the user name 707 is set in the item 806. Information indicating whether or not the check box 708 is selected is set in the item 807. A value set in the password 709 is set in the item 808. Information indicating whether or not the check box 710 is selected is set in the item 809. Values set in the items 711, that is, setting values of the “paper sheet size”, the “two-sided”, the “color mode”, the “number of copies”, and the “paper feeding unit” are set in the item 810. Information indicating whether or not the check box 712 is selected and a value set in the schedule setting 713, are set in the item 811.

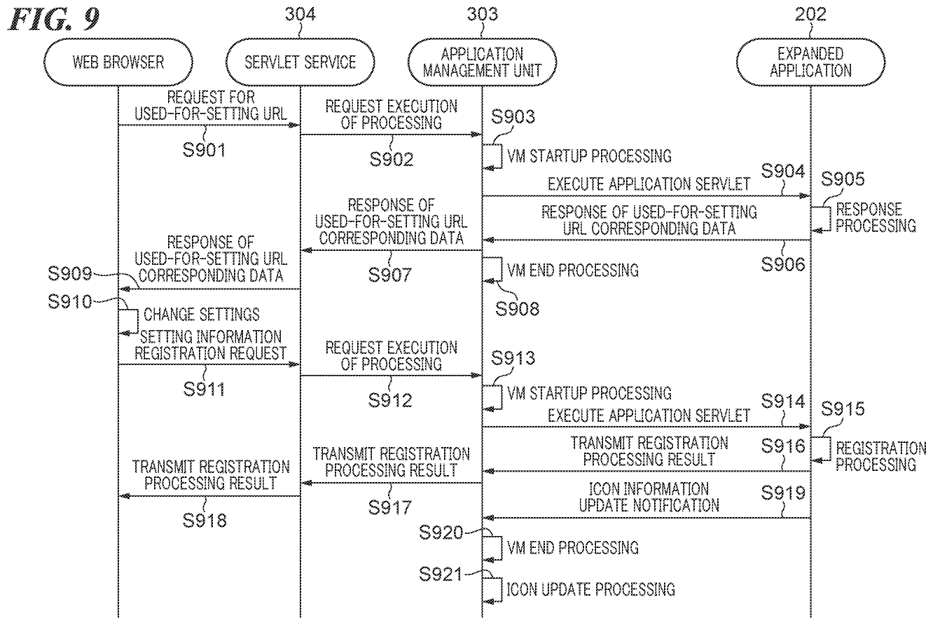

FIG. 9 is a sequence diagram that shows procedures of an expanded application setting processing, which is performed based on settings of the setting screen 701 of FIG. 7. The expanded application setting processing of FIG. 9 is realized by the CPU 102 executing the program stored in the storage 105. As an example, FIG. 9 describes a processing of generating the icon of the expanded application 202, which is a form printing application that prints form image data registered by the user. As described above, the settings of the expanded application 202 are set on the setting screen 701, which is displayed on the web browser running on the host PC 402.

As shown in FIG. 9, at first, the host PC 402 designates a used-for-setting URL for setting the expanded application 202, and makes a request of setting the expanded application 202 to the servlet service 304 of the image forming apparatus 100 from the web browser (a step S901).

The servlet service 304 of the image forming apparatus 100, which has received the request of setting the expanded application 202, requests the application management unit 303 to perform the processing (a step S902). The application management unit 303 specifies an application corresponding to the designated used-for-setting URL, and performs a VM startup processing of the specified application, specifically, the expanded application 202 (a step S903). Next, the application management unit 303 executes an application servlet (a step S904). In the step S904, the application management unit 303 notifies the expanded application 202, which is the specified application, of the above used-for-setting URL. The expanded application 202 performs a response processing for the request of the designated used-for-setting URL (a step S905). In the step S905, the expanded application 202 prepares to return an HTML (Hyper Text Markup Language) resource for the used-for-setting URL. In this HTML resource, HTML FORM for setting the setting data 801 necessary for a form printing processing is described. The expanded application 202 responds to data corresponding to the used-for-setting URL (hereinafter, referred to as “used-for-setting URL corresponding data”) (a step S906). Specifically, the expanded application 202 transmits the prepared HTML resource to the application management unit 303. As a result, the processing by the expanded application 202 ends.

The application management unit 303 responds to the used-for-setting URL corresponding data (a step S907). Specifically, the application management unit 303 transfers the received HTML resource to the servlet service 304. Next, the application management unit 303 performs a VM end processing based on the end of the processing by the expanded application 202 (a step S908). The servlet service 304 responds to the used-for-setting URL corresponding data (a step S909). Specifically, the servlet service 304 transmits the received HTML resource as it is to the host PC 402. Based on the HTML resource, the setting screen 701 is displayed on the web browser of the host PC 402.

After that, the user changes the settings of the expanded application 202 from the setting screen 701 displayed on the web browser of the host PC 402 (a step S910). In the step S910, it is assumed that a new printing form has been registered. The web browser makes a setting information registration request to the servlet service 304 according to an instruction by the user (a step S911).

The servlet service 304 of the image forming apparatus 100, which has received the setting information registration request, requests the application management unit 303 to perform the processing (a step S912). Next, in steps S913 and S914, as with the steps S903 and S904, the application management unit 303 specifies a corresponding application from the used-for-setting URL, and executes an application servlet of the specified application. The expanded application 202, which is the specified application, processes the request from the web browser, and performs a registration processing that registers setting information of the new printing form (a step S915). Next, the expanded application 202 transmits a registration processing result, which indicates that the registration of the setting information has been completed, to the application management unit 303 (a step S916). The application management unit 303 transfers the registration processing result to the servlet service 304 (a step S917). The servlet service 304 transmits the received registration processing result as it is to the host PC 402 (a step S918).

After performing the registration processing of the step S915, the expanded application 202 transmits an icon information update notification, which registers the icon associated with the registered setting information, to the application management unit 303 (a step S919), and then the processing by the expanded application 202 ends. The application management unit 303 performs the VM end processing based on the end of the processing by the expanded application 202 (a step S920), and performs an icon update processing (a step S921). As a result, the registered icon is displayed on the main menu screen, which is displayed on the operating unit 107. When this icon is pressed, the setting information corresponding to this icon is called, and a printing job is submitted based on this setting information. In the image forming apparatus 100, the servlet service 304, the application management unit 303, and the expanded application 202 function as a registering unit.

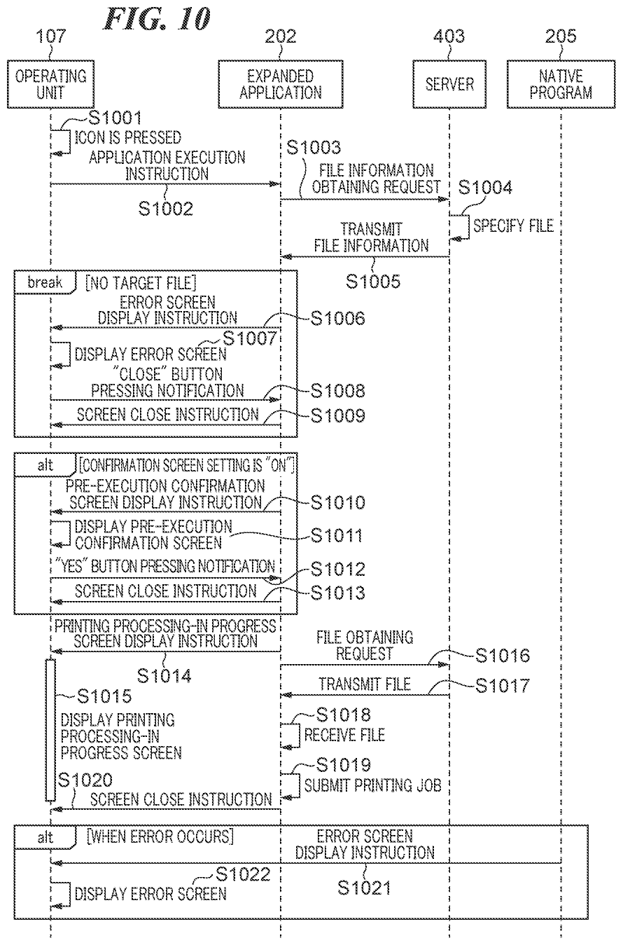

FIG. 10 is a sequence diagram that shows procedures of a printing job control processing, which is performed when the icon of the expanded application 200 displayed on the operating unit 107 of FIG. 1 is pressed. The printing job control processing of FIG. 10 is realized by the CPU 102 executing the program stored in the storage 105.

As shown in FIG. 10, when the icon of the expanded application 202 displayed on the operating unit 107 is pressed (a step S1001), the operating unit 107 gives an application execution instruction to the expanded application 202 (a step S1002). Upon receiving the application execution instruction, the expanded application 202 makes a file information obtaining request based on the value of the item 805 in the setting data 801 corresponding to the pressed icon (a step S1003). In FIG. 10, it is assumed that the value of the item 805 in the setting data 801 corresponding to the pressed icon indicates a file stored in the server 403 or a folder, in which the said file is stored. In the step S1003, the expanded application 202 makes the file information obtaining request to the server 403.

The server 403 specifies a file corresponding to the above file information obtaining request from a plurality of files to be retained (a step S1004). In the step S1004, in the case that the value of the item 805 in the setting data 801 described above indicates a certain file, this file is specified as the file corresponding to the above file information obtaining request. On the other hand, in the case that the value of the item 805 in the setting data 801 described above indicates a certain folder, all the files stored in this folder are specified as the files corresponding to the above file information obtaining request. Next, the server 403 transmits information indicating the file specified in the step S1004 (hereinafter, referred to as “file information”) to the expanded application 202 (a step S1005). Moreover, in the case that the file corresponding to the above file information obtaining request is not specified in the step S1004, the server 403 transmits file information not including the information indicating the file to the expanded application 202 in the step S1005.

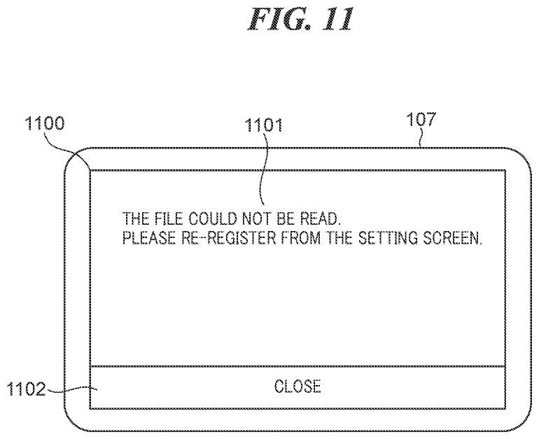

For example, in the case that the file information received from the server 403 does not include the information indicating the file, the expanded application 202 gives an error screen display instruction to the operating unit 107 (a step S1006). The operating unit 107 displays a file error screen 1100 of FIG. 11 according to the error screen display instruction received from the expanded application 202 (a step S1007). On the file error screen 1100, a message 1101 indicating that the obtaining of the file has failed and a “close” button 1102 are displayed. When the “close” button 1102 is pressed, the operating unit 107 transmits a notification indicating that the “close” button 1102 is pressed (hereinafter, referred to as “a “close” button pressing notification”) to the expanded application 202 (a step S1008). Upon receiving the “close” button pressing notification, the expanded application 202 gives an instruction that closes the file error screen 1100 (a screen close instruction) to the operating unit 107 (a step S1009), and the printing job control processing ends.

On the other hand, in the case that the file information received from the server 403 includes the information indicating the file, the expanded application 202 gives a pre-execution confirmation screen display instruction to the operating unit 107 (a step S1010). When the operating unit 107 receives the pre-execution confirmation screen display instruction from the expanded application 202, the operating unit 107 displays the pre-execution confirmation screen 1200 of FIG. 12 (a step S1011). The pre-execution confirmation screen 1200 includes a message 1201 for confirming whether or not to execute printing, a “YES” button 1202 and a “NO” button 1203 for giving an instruction to the said message 1201. Further, the pre-execution confirmation screen 1200 includes a folder path 1204 of the file indicated in the file information, the number of files 1205 indicated in the file information, and the setting values set on the setting screen 701. When the folder path 1204 is pressed, the operating unit 107 displays a screen 1206, which shows the detailed information of the folder path. When the number of files 1205 is pressed, the operating unit 107 displays a list screen 1207 of files indicated in the file information, which is obtained in the step S1005. When the “YES” button 1202 is pressed, the operating unit 107 transmits a notification indicating that the “YES” button 1202 is pressed (a predetermined operation) (hereinafter, referred to as “a “YES” button pressing notification”) to the expanded application 202 (a step S1012). Upon receiving the “YES” button pressing notification, the expanded application 202 gives an instruction that closes the pre-execution confirmation screen 1200 (the screen close instruction) to the operating unit 107 (a step S1013).

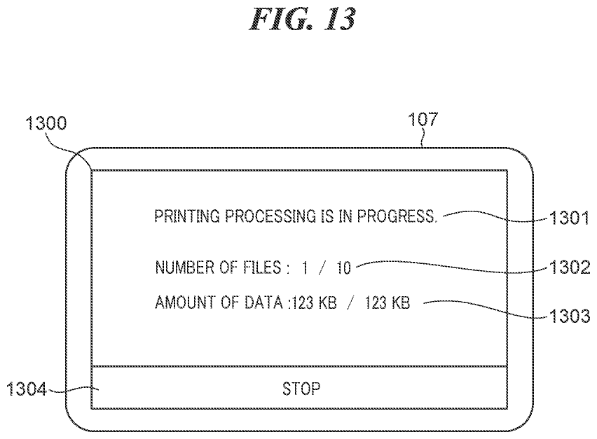

Next, the expanded application 202 gives a printing processing-in progress screen display instruction to the operating unit 107 (a step S1014). The operating unit 107 displays a printing processing-in progress screen 1300 of FIG. 13 according to the printing processing-in progress screen display instruction (a step S1015). The printing processing-in progress screen 1300 includes a message 1301 indicating that printing processing is in progress, the number of processed files with respect to the number of files to be printed 1302, and the amount of submitted data with respect to the total data amount of the file being processed 1303. The printing processing-in progress screen 1300 further includes a stop button 1304 for stopping the printing processing.

After giving the printing processing-in progress screen display instruction to the operating unit 107 in the step S1014, the expanded application 202 makes a file obtaining request to the server 403 (a step S1016). The server 403 transmits a file corresponding to the file obtaining request, which is received from the expanded application 202, to the image forming apparatus 100 (a step S1017).

The expanded application 202 of the image forming apparatus 100 receives the file from the server 403 (a step S1018), and submits a printing job for printing the received file (a step S1019).

Next, the expanded application 202 gives an instruction that closes the printing processing-in progress screen 1300 (the screen close instruction) to the operating unit 107 (a step S1020), and the printing job control processing ends.

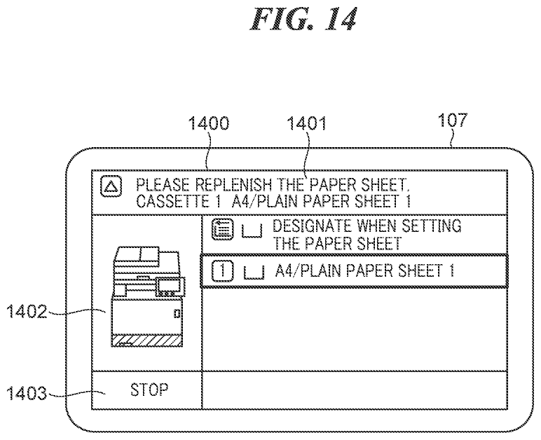

In the case that an error such as paper absence or paper jamming occurs when executing the submitted printing job, the native program 205 gives an error screen display instruction to the operating unit 107 (a step S1021). The operating unit 107 displays an error screen 1400 of FIG. 14 according to this error screen display instruction (a step S1022). The error screen 1400 includes a message 1401 that prompts for replenishment of paper sheet, an image 1402 that shows the paper feeding unit of paper sheet, and a stop button 1403 for stopping the job.

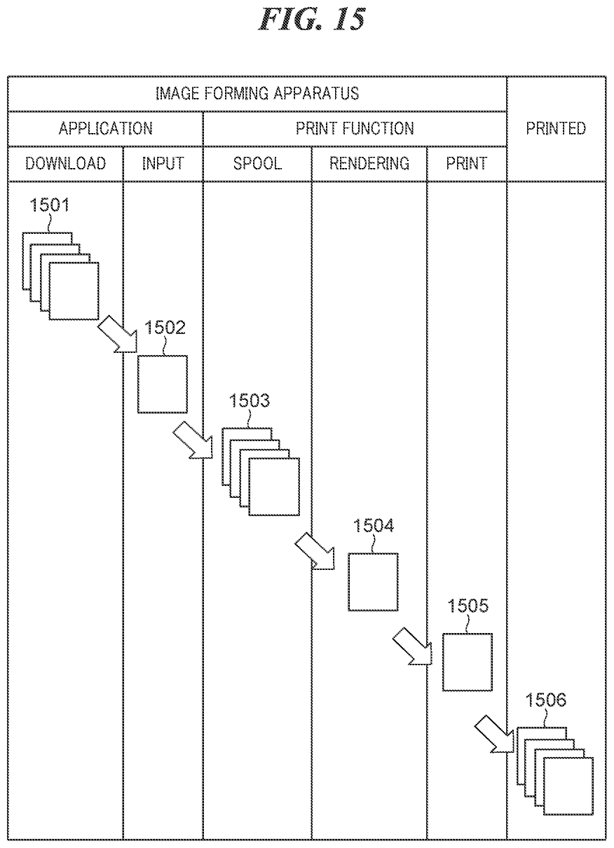

FIG. 15 is a figure for explaining operations of the image forming apparatus 100 in the case of printing a multi-page document. In the case of printing the multi-page document, the expanded application 202 downloads the multi-page document from the server 403 (for example, see 1501 in FIG. 15). The expanded application 202 sequentially inputs the data being downloaded into the print function (for example, see 1502 in FIG. 15). The inputted data is spooled (for example, see 1503 in FIG. 15). Rendering is performed with respect to the spooled data (for example, see 1504 in FIG. 15), the rendered data is printed (for example, see 1505 in FIG. 15), and a printed matter is outputted (for example, see 1506 in FIG. 15).

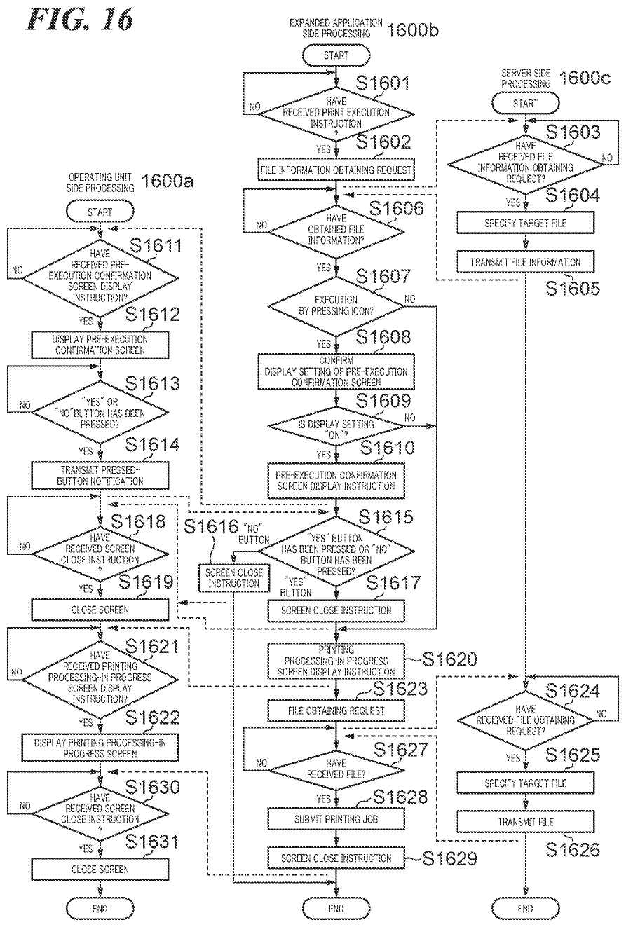

FIG. 16 is a flowchart that shows procedures of a printing job submitting processing executed by the image forming apparatus 100 and the server 403 in the present embodiment. In the printing job submitting processing of FIG. 16, processing executed by the image forming apparatus 100 is realized by the CPU 102 executing the program stored in the storage 105. Further, operating unit side processing 1600a, which includes each process of steps S1611 to S1614, S1618 to S1619, S1621, S1622, and S1630 to S1631 in FIG. 16, is processing executed by the operating unit 107. Furthermore, expanded application side processing 1600b, which includes each process of steps S1601 to S1602, S1606 to S1610, S1615 to S1617, S1620, S1623, and S1627 to S1629 in FIG. 16, is processing executed by the expanded application 202. Moreover, server side processing 1600c, which includes each process of steps S1603 to S1605, and S1624 to S1626 in FIG. 16, is processing executed by the server 403.

As shown in FIG. 16, at first, the expanded application 202 waits until receiving a print execution instruction. Upon receiving the print execution instruction (YES in the step S1601), the expanded application 202 makes a file information obtaining request, which requests obtaining of file information indicating a file corresponding to the print execution instruction, to the server 403. The expanded application 202 waits until obtaining the above file information from the server 403.

On the other hand, when the server 403 receives the file information obtaining request (YES in the step S1603), the server 403 specifies a file corresponding to the file information obtaining request from a plurality of files to be retained (the step S1604). Next, the server 403 transmits file information indicating the specified file to the expanded application 202 (the step S1605).

When the expanded application 202 obtains the file information from the server 403 (YES in the step S1606), the expanded application 202 judges whether or not the above print execution instruction is an instruction issued by pressing the icon of the expanded application 202 (the step S1607). For example, in the case that the above print execution instruction is a print execution instruction issued when a time point set in the printing schedule setting is reached, the expanded application 202 judges that the above print execution instruction is not the instruction issued by pressing the icon of the expanded application 202.

As a result of judging in the step S1607, in the case that the above print execution instruction is not the instruction issued by pressing the icon of the expanded application 202, processes of the steps S1608 to S1619, which will be described later and are processing related to the display of the pre-execution confirmation screen 1200, are not performed, and the printing job submitting processing proceeds to the step S1620. That is, in the present embodiment, when the print timing condition set in the printing schedule setting is satisfied, the pre-execution confirmation screen 1200 is not displayed.

As the result of the judging in the step S1607, in the case that the above print execution instruction is the instruction issued by pressing the icon of the expanded application 202, the expanded application 202 confirms a display setting of the pre-execution confirmation screen (the step S1608). Specifically, the expanded application 202 confirms the setting value of the item 809 of the setting data 801 corresponding to the pressed icon. Next, the expanded application 202 judges whether or not the display setting of the pre-execution confirmation screen is enabled (the step S1609). In the step S1608, in the case that the setting value of the item 809 of the setting data 801 described above indicates the selected state of the check box 710 of the setting screen 701, the expanded application 202 judges that the display setting of the pre-execution confirmation screen is enabled. On the other hand, in the case that the setting value of the item 809 of the setting data 801 corresponding to the pressed icon indicates an unselected state of the check box 710 of the setting screen 701, the expanded application 202 judges that the display setting of the pre-execution confirmation screen is disabled.

As a result of judging in the step S1609, in the case that the display setting of the pre-execution confirmation screen is disabled (OFF), the processes of the steps S1608 to S1619, which will be described later and are the processing related to the display of the pre-execution confirmation screen 1200, are not performed, and the printing job submitting processing proceeds to the step S1620. As the result of the judging in the step S1609, in the case that the display setting of the pre-execution confirmation screen is enabled (ON), the expanded application 202 gives the pre-execution confirmation screen display instruction to the operating unit 107 (the step S1610).

When the operating unit 107 receives the pre-execution confirmation screen display instruction from the expanded application 202 (YES in the step S1611), the operating unit 107 displays the pre-execution confirmation screen 1200 (the step S1612). Next, the operating unit 107 waits until any one of the “YES” button 1202 and the “NO” button 1203 is pressed by the user on the pre-execution confirmation screen 1200. When the “YES” button 1202 or the “NO” button 1203 is pressed by the user (YES in the step S1613), the operating unit 107 transmits a pressed-button notification indicating the pressed button to the expanded application 202 (the step S1614).

When the expanded application 202 receives the pressed-button notification from the operating unit 107, the expanded application 202 judges whether this pressed-button notification indicates the “YES” button 1202 or the “NO” button 1203 (the step S1615).

As a result of judging in the step S1615, in the case that the pressed-button notification indicates the “NO” button 1203, the expanded application 202 gives the screen close instruction to the operating unit 107 (the step S1616), and the printing job submitting processing ends.

As the result of the judging in the step S1615, in the case that the pressed-button notification indicates the “YES” button 1202, the expanded application 202 gives the screen close instruction to the operating unit 107 (the step S1617).

When the operating unit 107 receives the screen close instruction from the expanded application 202 (YES in the step S1618), the operating unit 107 closes the pre-execution confirmation screen 1200 (the step S1619). After that, the operating unit 107 waits until receiving another instruction from the expanded application 202.

On the other hand, after giving the screen close instruction in the step S1617, the expanded application 202 gives the printing processing-in progress screen display instruction to the operating unit 107 (the step S1620).

When the operating unit 107 receives the printing processing-in progress screen display instruction from the expanded application 202 (YES in the step S1621), the operating unit 107 displays the printing processing-in progress screen 1300 (the step S1622). Next, the operating unit 107 waits until receiving the screen close instruction from the expanded application 202.

After giving the printing processing-in progress screen display instruction to the operating unit 107 in the step S1620, the expanded application 202 makes an obtaining request of a file corresponding to the file information to the server 403 (the step S1623).

When the server 403 receives the obtaining request of the above file from the expanded application 202 (the step S1624), the server 403 specifies files corresponding to the obtaining request of the above file from a plurality of files to be retained (the step S1625). Next, the server 403 transmits all the specified files to the expanded application 202 (the step S1626), and then the processing by the server 403 ends.

When the expanded application 202 receives the file from the server 403 (YES in the step S1627), the expanded application 202 submits a printing job according to the above print execution instruction (the step S1628). Next, the expanded application 202 gives the screen close instruction to the operating unit 107 (the step S1629), and the processing by the expanded application 202 ends. When the operating unit 107 receives the screen close instruction (YES in the step S1630), the operating unit 107 closes the printing processing-in progress screen 1300 (the step S1631), and the printing job submitting processing ends.

According to the above-described embodiment, by satisfying the print timing condition set in the printing schedule setting, the pre-execution confirmation screen 1200 is not displayed on the operating unit 107, and printing is performed based on the printing setting associated with the above icon. That is, when the printing by the printing schedule setting is started, the pre-execution confirmation screen 1200 will never be displayed on the operating unit 107. As a result, it is possible to prevent the phenomenon that the printing by the printing schedule setting will not be started due to the display of the pre-execution confirmation screen 1200.

Further, in the above-described embodiment, by satisfying the print timing condition set in the printing schedule setting, the pre-execution confirmation screen 1200 is not displayed on the operating unit 107 regardless of the display setting of the pre-execution confirmation screen. As a result, it is possible to certainly prevent the display of the pre-execution confirmation screen 1200 when the printing by the printing schedule setting is started.

Furthermore, in the above-described embodiment, the image forming apparatus 100 has the expanded application 202, which submits the printing job based on the associated printing setting, and the VM 204, which executes the expanded application 202. As a result, it is possible to prevent the phenomenon that the printing job by the printing schedule setting, which is submitted by the expanded application 202, will not be started due to the display of the pre-execution confirmation screen 1200.

Moreover, in the above-described embodiment, the printing schedule setting includes a printing start time point for each day of the week. As a result, it is possible to prevent the phenomenon that the printing at the printing start time set for each day of the week will not be started due to the display of the pre-execution confirmation screen 1200.

Further, in the above-described embodiment, the pre-execution confirmation screen 1200 is a screen that allows the user to confirm the printing setting. As a result, it is possible to prevent the printing by the printing schedule setting, which allows printing to start at a set time point without being near the image forming apparatus 100, from becoming unusable.

Although the present invention has been described above with reference to the above-described embodiment, the present invention is not limited to the above-described embodiment. For example, by satisfying the print timing condition set in the printing schedule setting, the file error screen 1100, which is displayed according to the fact that the file to be printed corresponding to the printing setting is not stored in the server 403, may not be displayed on the operating unit 107.

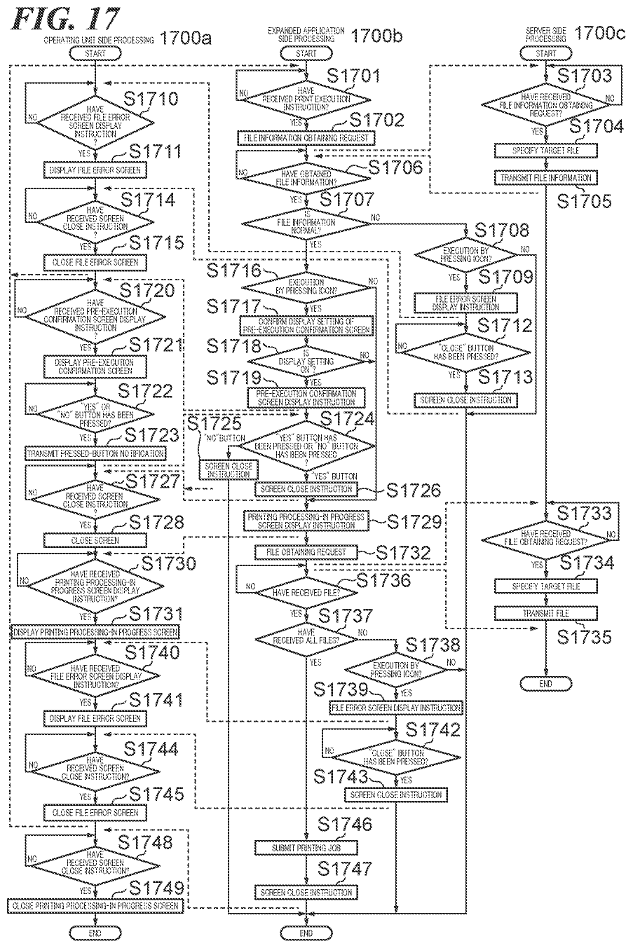

FIG. 17 is a flowchart that shows procedures of another printing job submitting processing executed by the image forming apparatus 100 and the server 403 in the present embodiment. In the another printing job submitting processing of FIG. 17, processing executed by the image forming apparatus 100 is realized by the CPU 102 executing the program stored in the storage 105. Further, operating unit side processing 1700a, which includes each process of steps S1710 to S1711, S1714 to S1715, S1720 to S1723, S1727 to S1728, S1730 to S1731, S1740 to S1741, S1744 to S1745, and S1748 to S1749 in FIG. 17, is processing executed by the operating unit 107. Furthermore, expanded application side processing 1700b, which includes each process of steps S1701 to S1702, S1706 to S1707, S1716 to S1719, S1724 to S1726, S1729, S1732, S1736 to S1739, S1742 to S1743, and S1746 to S1747 in FIG. 17, is processing executed by the expanded application 202. Further, server side processing 1700c, which includes each process of steps S1703 to S1705, and S1733 to S1735 in FIG. 17, is processing executed by the server 403. Moreover, the another printing job submitting processing of FIG. 17 is similar to the printing job submitting processing of FIG. 16, and the contents different from the printing job submitting processing of FIG. 16 will be described below.

As shown in FIG. 17, in the another printing job submitting processing, the processes of the steps S1701 to S1706, which are the same processes as the above-mentioned steps S1601 to S1606, are executed. When the expanded application 202 obtains the file information from the server 403 (YES in the step S1706), the expanded application 202 judges whether or not the file information is normal (the step S1707). In the step S1707, for example, in the case that the obtained file information includes information indicating at least one file, the expanded application 202 judges that the file information is normal. On the other hand, in the case that the obtained file information does not include information indicating the file, that is, in the case that the file corresponding to the print execution instruction is not stored in the server 403, the expanded application 202 judges that the file information is not normal.

As a result of judging in the step S1707, in the case that the file information is not normal, the expanded application 202 judges whether or not the above print execution instruction is the instruction issued by pressing the icon of the expanded application 202 (the step S1708). In the step S1708, as with the step S1607, for example, in the case that the above print execution instruction is the print execution instruction issued when the time point set in the printing schedule setting is reached, the expanded application 202 judges that the above print execution instruction is not the instruction issued by pressing the icon of the expanded application 202.

As a result of judging in the step S1708, in the case that the above print execution instruction is not the instruction issued by pressing the icon of the expanded application 202, processes of the steps S1709 to S1715, which will be described later and is processing related to the display of the file error screen 1100, are not performed, and the another printing job submitting processing ends. That is, in the present embodiment, when the print timing condition set in the printing schedule setting is satisfied, even in the case that the file corresponding to the print execution instruction is not stored in the server 403, the file error screen 1100 is not displayed.

As the result of the judging in the step S1708, in the case that the above print execution instruction is the instruction issued by pressing the icon of the expanded application 202, the expanded application 202 gives a file error screen display instruction to the operating unit 107 (the step S1709).

When the operating unit 107 receives the file error screen display instruction from the expanded application 202 (YES in the step S1710), the operating unit 107 displays the file error screen 1100 (the step S1711).

On the other hand, when the “close” button 1102 of the file error screen 1100 displayed on the operating unit 107 is pressed by the user (YES in the step S1712), the expanded application 202 performs the process of the step S1713. In the step S1713, the expanded application 202 gives the screen close instruction, which closes the file error screen 1100, to the operating unit 107.

When the operating unit 107 receives the screen close instruction from the expanded application 202 (YES in the step S1714), the operating unit 107 closes the file error screen 1100 (the step S1715), and the another printing job submitting processing returns to the step S1701.

As the result of the judging in the step S1707, in the case that the file information is normal, in the another printing job submitting processing, the processes of the steps S1716 to S1736, which are the same processes as the above-mentioned steps S1607 to S1627, are executed. Next, the expanded application 202 judges whether or not all the files, which are indicated by the file information obtained in the step S1706, have been received (the step S1737).

As a result of judging in the step S1737, in the case that all the files, which are indicated by the file information obtained in the step S1706, have been received, in the another printing job submitting processing, the processes of the steps S1746 to S1749, which are the same processes as the above-mentioned steps S1628 to S1631, are performed, and the another printing job submitting processing ends.

As the result of the judging in the step S1737, in the case that any one of all the files, which are indicated by the file information obtained in the step S1706, has not been received, the expanded application 202 judges whether or not the above print execution instruction is the instruction issued by pressing the icon of the expanded application 202 (the step S1738). In the step S1738, as with the step S1708, for example, in the case that the above print execution instruction is the print execution instruction issued when the time point set in the printing schedule setting is reached, the expanded application 202 judges that the above print execution instruction is not the instruction issued by pressing the icon of the expanded application 202.

As a result of judging in the step S1738, in the case that the above print execution instruction is not the instruction issued by pressing the icon of the expanded application 202, the another printing job submitting processing ends. As the result of the judging in the step S1738, in the case that the above print execution instruction is the instruction issued by pressing the icon of the expanded application 202, the expanded application 202 gives the file error screen display instruction to the operating unit 107 (the step S1739).

When the operating unit 107 receives the file error screen display instruction from the expanded application 202 (YES in the step S1740), the operating unit 107 displays the file error screen 1100 (the step S1741).

On the other hand, when the “close” button 1102 of the file error screen 1100 displayed on the operating unit 107 is pressed by the user (YES in the step S1742), the expanded application 202 performs the process of the step S1743. In the step S1743, the expanded application 202 gives the screen close instruction, which closes the file error screen 1100, to the operating unit 107.

When the operating unit 107 receives the screen close instruction from the expanded application 202 (YES in the step S1744), the operating unit 107 closes the file error screen 1100 (the step S1745), and the another printing job submitting processing returns to the step S1701.

In the above-described embodiment, by satisfying the print timing condition set in the printing schedule setting, the file error screen 1100, which is displayed according to the fact that the file to be printed corresponding to the printing setting is not stored in the server 403, is not displayed on the operating unit 107. As a result, it is possible to prevent the image forming apparatus 100 from being unavailable to another user different from the user who has given the execution instruction of the printing by the printing schedule setting due to the display of the file error screen 1100.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-178839, filed Oct. 26, 2020, which is hereby incorporated by reference herein in its entirety.

What is claimed is:

1. An image forming apparatus comprising:
a display unit;
a registering unit configured to register an object associated with a print timing condition and a printing setting designated by a user; and
a printing unit configured to print an image on a paper sheet,
wherein when the object displayed on the display unit is selected, the display unit displays a confirmation screen,
wherein according to accepting of a predetermined operation in a state that the confirmation screen is displayed, the printing unit prints an image on a paper sheet based on the printing setting, and
wherein by satisfying the print timing condition, the display unit does not display the confirmation screen, and the printing unit prints the image on the paper sheet based on the printing setting.

2. The image forming apparatus according to claim 1,
wherein a display setting that indicates whether or not to make the display unit to display the confirmation screen is set, and
wherein regardless of the display setting, by satisfying the print timing condition, the display unit does not display the confirmation screen.

3. The image forming apparatus according to claim 1, further comprising:
an application configured to correspond to the object and submit a job for making the printing unit to print the image on the paper sheet based on the printing setting; and
an execution environment for executing the application.

4. The image forming apparatus according to claim 1,
wherein the print timing includes a printing start time point for each day of a week.

5. The image forming apparatus according to claim 1,
wherein the confirmation screen is a screen that allows the user to confirm the printing setting.

6. The image forming apparatus according to claim 1, further comprising:
an obtaining unit configured to obtain data to be printed from an information processing apparatus, and
wherein by satisfying the print timing condition, the display unit does not display an error screen, which is displayed according to a fact that data to be printed corresponding to the printing setting is not stored in the information processing apparatus.

7. A control method for an image forming apparatus that comprises a display unit, the control method comprising:
making the display unit to display a screen;
registering an object associated with a print timing condition and a printing setting designated by a user; and
printing an image on a paper sheet,
wherein when the object displayed on the display unit is selected, a confirmation screen is displayed on the display unit,
wherein according to accepting of a predetermined operation in a state that the confirmation screen is displayed, an image is printed on a paper sheet based on the printing setting, and
wherein by satisfying the print timing condition, the image is printed on the paper sheet based on the printing setting without displaying the confirmation screen on the display unit.

8. A non-transitory computer-readable storage medium storing a program for causing a computer to execute a control method for an image forming apparatus that comprises a display unit, the control method comprising:
making the display unit to display a screen;
registering an object associated with a print timing condition and a printing setting designated by a user; and
printing an image on a paper sheet,
wherein when the object displayed on the display unit is selected, a confirmation screen is displayed on the display unit,
wherein according to accepting of a predetermined operation in a state that the confirmation screen is displayed, an image is printed on a paper sheet based on the printing setting, and
wherein by satisfying the print timing condition, the image is printed on the paper sheet based on the printing setting without displaying the confirmation screen on the display unit.
